(19) United States
(12) Patent Application Publication
(10) Pub. No.: US 2010/0000055 A1
(43) Pub. Date: Jan. 7, 2010

(54) FIXING SYSTEM

(76) Inventor: Konstantinos Poulakis, Hildrizhausen (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/449,069

(22) PCT Filed: Feb. 9, 2008
(86) PCT No.: PCT/EP2008/001001

§ 371 Date: Jul. 22, 2009

(30) Foreign Application Priority Data
Mar. 15, 2007 (DE) 10 2007 012 433.5

(51) Int. Cl. B65D 33/18; F16B 47/00; A44B 18/00

(52) U.S. Cl. 24/30.5 R; 24/304; 156/71

(57) ABSTRACT

A fixing system consists of at least one adhesion closure part (9) which can be fixed by its fixing side (7) onto the free side (19) of a fixing part (11), the other functional side of which is at least partially provided with an active substance (15) which can be activated, which when activated, forms a fixing connection with the fixing side (5) of a third part (1, 3).

The invention relates to fixing systems in which one component is formed from a combination consisting of several parts by at least one adhesion closure part.

In such fixing systems there is the fundamental problem of forming a fixed and reliable connection between the fixing side of the participating adhesion closure parts which is opposite the interlocking side, and an assigned further part of the combination which is to be formed. The formation of this connection is difficult to produce in all cases or cannot be produced with sufficient reliability when the composition (surface structure) of the pertinent system part is not suited to attaching the conventionally self-adhesive fixing side of the adhesion closure part. This problem appears especially when the pertinent system parts are foam parts, parts with a textile surface or other system parts with surface structuring which are not suitable for cementing an adhesion closure part with a self-adhesive fixing side.

According to the prior art, in these cases the process is such that a cement connection is produced such that a liquid or spreadable solvent-containing adhesive is applied to the fixing side of the adhesion closure part and of the participating further part, for example, is brushed on, after which, after a certain airing time, the adhesion closure part is laminated onto the fixing side of the pertinent part. Due to evaporation of the solvent, the use of these adhesives which, for example, contain nitrile rubber in a solvent is extremely problematical. Since the use of these fixing systems often takes place within at least partially closed spaces, evaporating solvent leads to adverse health effects and injury to personnel, as far as disorientation. Therefore in many cases it is necessary to provide protective measures, for example, prescribed breaks, forced ventilation or breathing apparatus for personnel.

In this respect, the object of the invention is to make available a fixing system which avoids the aforementioned disadvantages of the prior art.

This object is achieved according to the invention by a fixing system which has the features of claim 1 in its entirety.

One important feature of the invention consists in that instead of cementing between the fixing side of the adhesion closure part and the system part to be attached to it by means of a solvent adhesive, a fixing part is used as an intermediate element which on its action side is provided with an active substance which when activated forms a fixing connection to the fixing side of the pertinent system part to which the adhesion closure part is to be connected. The fixing part connected by activating its active substance to a third part thus forms a system element by which the problematic surface structure of the third part is conditioned such that the adhesion closure part which is conventionally finished to be self-adhesive can be attached by cementing to the free side of the fixing part, the connection in turn taking place free of solvent.

The third part on whose surface the fixing part is fixed by way of the activated active substance can be a carrier part, for example, a cushion foam part of a vehicle or aircraft seat. In this case the adhesion closure part connected to the cushion foam part by way of the fixing part can be used, for example, as an anchoring element for a seat covering or the like.

In one especially advantageous embodiment, the third part can be a useful part, in particular, a covering, preferably a floor or wall covering, the useful part having a useful surface opposite its fixing side.

In an especially advantageous manner the fixing system in this connection can be used as an installation system, the covering being at least one carpet or carpet tile with a carpet side which forms the useful surface and a carpet back which forms the fixing side. Since the installation of coverings such as carpets or tile takes place conventionally in closed spaces, the possibility of solvent-free working constitutes an especially valuable advantage. After attaching the fixing part, for example, to a carpet back, its fixing side is conditioned such that an adhesion closure part which is conventionally finished to be self-adhesive can be cemented to the fixing part, the connection in turn taking place without solvent. The cover part which has been prepared in this way, such as a carpet or carpet tile or wall tile, can then be fixed in the conventional manner by interlocking with an adhesion closure part anchored on a base.

The fixing system according to the invention is suited not only for coverings of the aforementioned type, but for coverings of any type, such as, for example, protective floor mats for ground vehicles and aircraft, bathroom mats, trunk mats and the like.

The fixing part can preferably be a flat article which is formed, in particular, from a plastic film and which on at least one side is provided with an active substance, in particular, is coated.

In especially preferred embodiments the active substance can be activated by heating.

Processing is made especially simple when an active substance which can be activated by heating is chosen such that heating to a temperature of less than 150° C., preferably less than 140° C., is sufficient to activate the active substance. In a temperature range limited in this way not only is the danger avoided that thermal degradation of the fixing part or the back of the third part will occur, but thermal lamination of the fixing part can also take place in an especially simple manner by pressing on; this can be done without difficulty at the installation site. The pertinent third parts, however, can also be mechanically provided with the fixing part beforehand by the manufacturer, and thus can be taken to the installation site prepared for installation.

A hot-melt adhesive has proven to be well-suited as the active substance; it consists of a blend of two thermoplastic substances, one with a softening point of not more than 125° C.

Thermoplastic materials suitable for this purpose can be chosen from the groups of copolyamides, polyethyl vinyl acetates, polyvinyl acetates, polyolefins, polyurethanes or copolyesters.

The active substance can also be a hot-melt adhesive based on synthetic rubber, however, processing temperatures there can be in the region of 170° C.

Preferably, the active substance on the flat article provided as the fixing part is applied in an application amount of 80 to 400 g/m², preferably roughly 200 g/m².

Handling is made especially simple and convenient when the fixing part is prepared such that it consists of two film lengths or strips, the side of one film provided with the active substance being covered by the second film which protects the active substance and which can be detached for exposing the active substance.

The subject matter of the invention is also a process for installing coverings using the fixing system according to the invention, the process having the features given in claim 14, and a kit which has system parts of the system according to the invention with at least the components given in claim 16.

The invention is detailed below using the drawings.

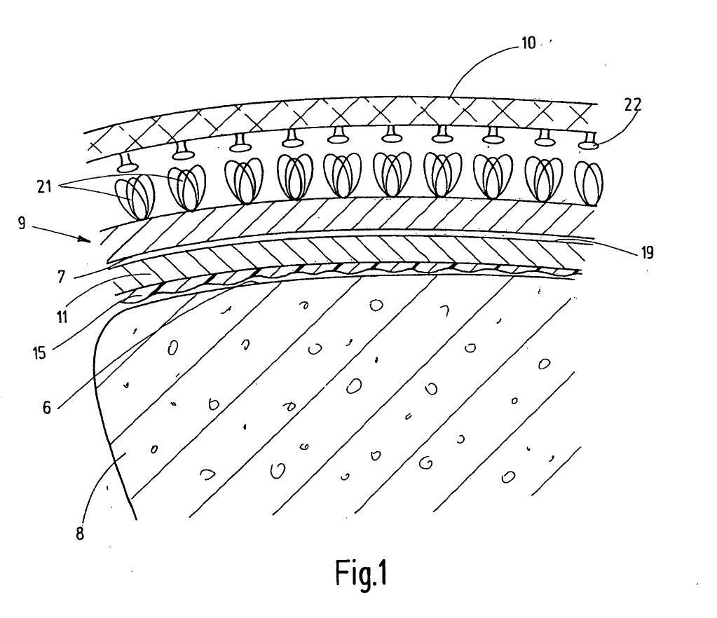

FIG. 1 shows a highly schematically simplified diagram for an explanation of the system according to the invention, the components being arranged at distances from one another and details being shown exaggerated and not to scale to simplify comprehension;

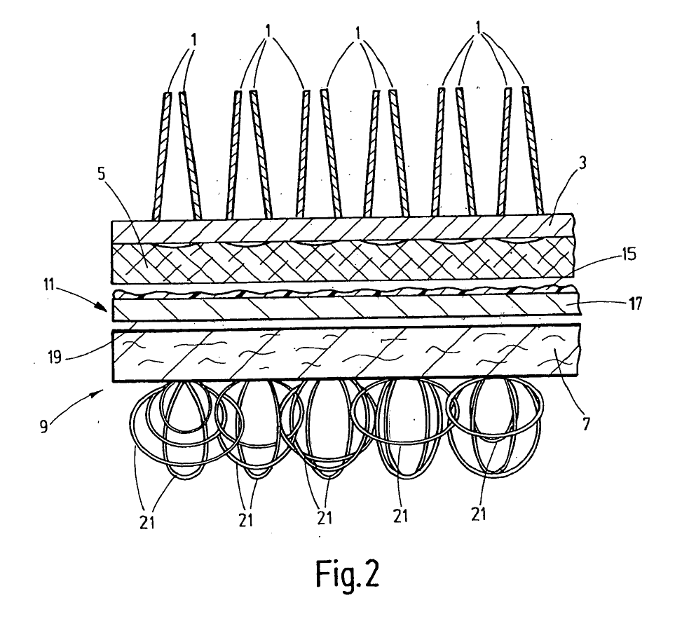

FIG. 2 shows a schematically simplified, broken away section of the components of the fixing system according to the invention in an application as an installation system, the components being arranged at distances from one another and details being shown on a highly exaggerated scale;

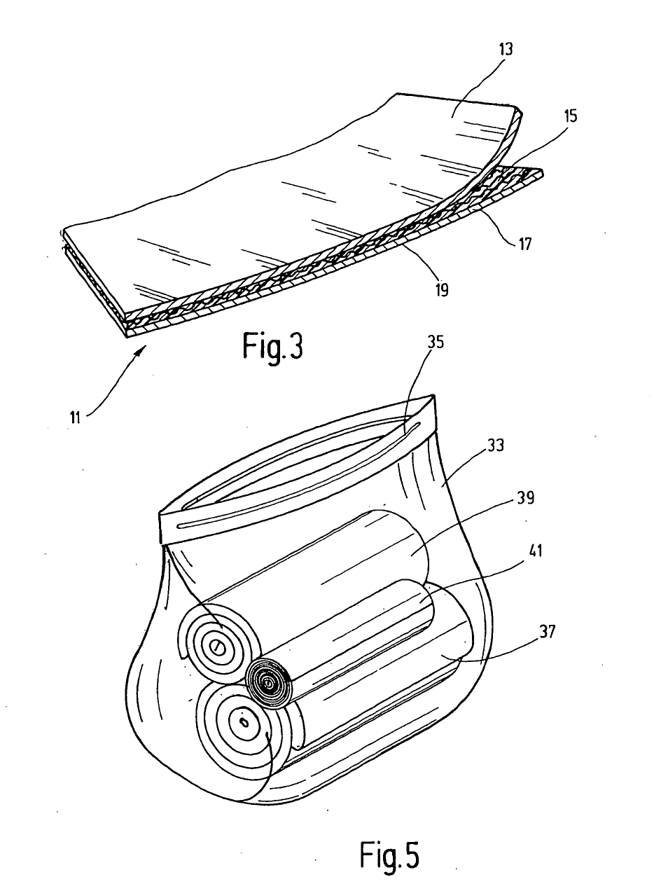

FIG. 3 shows a schematically simplified, broken away longitudinal section of the fixing part of the system according to the invention, the material thicknesses being shown likewise greatly enlarged;

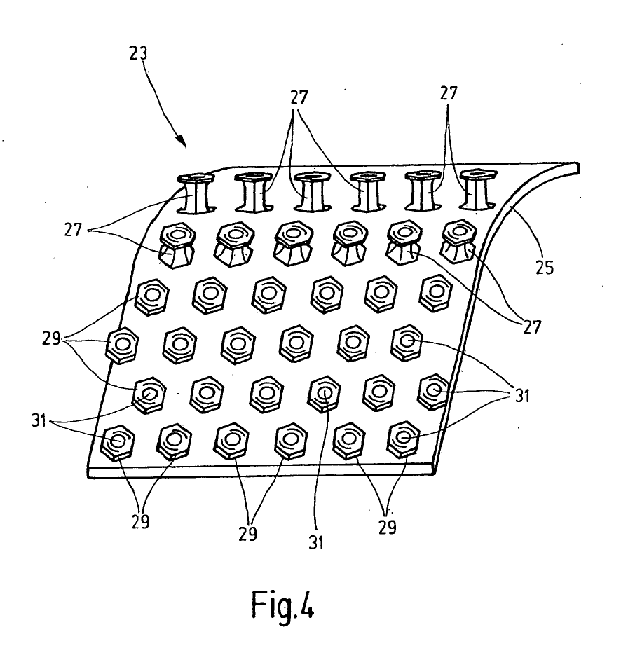

FIG. 4 shows a highly schematically simplified and exaggerated perspective oblique view of a partial region of a micro-adhesion closure part of the system according to the invention, and

FIG. 5 shows a simplified perspective oblique view of a bag with the system components contained in it.

FIG. 1 is intended to illustrate the invention using one example in which a schematically shown cushion foam part 8 (for example, PU foam) of a passenger seat forms the third part of the system which is used as a support part for an adhesion closure part 9. The adhesion closure part 9 which is to be attached to the cushion foam part 8 has a carrier 7 whose one side is used as the fixing side and on whose other side interlocking elements 21 (not all numbered in FIG. 1) are located which can be interlocked with interlocking elements 22 (likewise not all numbered) of another system element, for example with a seat covering 10.

The fixing side which is conventionally made self-adhesive on the carrier 7 of the adhesion closure part 9 due to the surface structure of the cushion foam part 8 cannot be easily cemented to the latter free of solvent. Therefore, according to the invention there is conditioning on the fixing side 6 of the cushion foam part 8. This is done with a fixing part 11 which is provided as an intermediate element and which on its active side is provided with an activatable active substance 15 which can be activated and, when activated, forms a connection to the fixing side 6 of the cushion foam part 8. The free side 19 of the fixing part 11, which side is opposite the active side, on which there is no surface contouring, enables direct, solvent-free cementing of the adhesion closure part 9. Attachment of the fixing part 11 to the cushion foam part 8 provided as the third part by activation of the active substance 15, which can take place thermally in advantageous embodiments which will be detailed below, results in conditioning on the fixing side 6 of the cushion foam part 8 so that the adhesion closure part 9 can be attached free of solvent.

FIG. 2 shows, in an enlarged, highly schematically simplified representation, a section of the cover part which forms a third part in the form of a floor carpet, whose useful surface has pile elements 1 of conventional type which extend up from a connecting layer 3. The carpet back 5 which is opposite the useful surface is formed by a loopless material. Materials which impart to the carpet structure a certain stiffness, directional stability and cutting strength can be used for this purpose. This can be loose gauze cloth or smooth right/left knits or so-called non-woven materials. Between the carpet back 5 and the carrier 7 of an adhesion closure part 9 is a fixing part 11 which is shown in FIG. 2 at a distance from the carpet back 5 and from the carrier 7 of the adhesion closure part 9, in FIG. 2 the fixing part 11 being shown in its processing state, a protective film 13, see FIG. 3, having already been detached. As FIG. 3 shows, the fixing part 11 forms a strip-like web with a flat article which forms the carrier for an active substance 15 and in which the illustrated embodiment is a heat-resistant plastic film 17 of polyester. FIG. 3 shows the release film or protective film 13 only partially detached from the side of the film 17 which has the active substance 15.

The free side 19 of the film 17 of the fixing part 11 is shown in FIG. 2 at a distance from the carrier 7 of the adhesion closure part 9. I.e., FIG. 2 shows the state before formation of a combination between the adhesion closure part 9 and the carpet back 5. This combination is produced by the fixing part 11 and the carpet back 5 being pressed against one another while heating of the active substance 15 is done, by which it is activated such that in a solvent-free joining process a fixed connection between the fixing part 11 and carpet back 5 takes place. For this purpose, the active substance 15 is a so-called hot-melt adhesive whose composition is chosen such that activation takes place by heating to a moderate temperature in which there is no adverse thermal effect on the participating system components. Suitable active substances which enable processing in temperature ranges of less than 150° C. are blends of thermoplastic substances, in particular blends which have softening points of not more than 125° C. Such blends make it possible to activate the substance 15 by pressing the fixing part 11 against the carpet back 5 with a heating tool or die, whose tool temperature is in the region of approximately 150° C. This means that the connection can be produced between the fixing part 11 and carpet back 5 by pressing on; this is possible without difficulties at the installation site.

Thermoplastic substances which are possible as components of these blends are, for example, copolyamides, polyethyl vinyl acetates, polyvinyl acetates, polyolefins, polyurethanes or copolyesters.

Hot-melt adhesives can also be those based on synthetic rubber, optionally comparatively somewhat higher processing temperatures having to be expected.

Application amounts of the hot-melt adhesives to the film 17 of the fixing part 11 are preferably amounts from 80 to 400 g/m², preferably 200 g/m² applied by coating.

The fixing part 11 fixed on the carpet back 5 enables on its free side 19 cementing of an adhesion closure part 9 finished to be self-adhesive in the conventional manner on the back of its carrier 7. The adhesion closure part in FIG. 2 for bonding to the other adhesion closure part anchored to the base, for example the floor, has adhesive elements in the form of loops 21. For formation of the adhesion closure with such an adhesion closure part 9, the base-side or floor-side adhesion closure part can be several types of adhesion closure parts, such as, for example, micro-adhesion closure parts, of which FIG. 4 shows a sample embodiment and is designated as 23. Micro-adhesion closure parts as can be produced, for example, by means of the process described in DE 198 28 856 C1 have a film-like carrier 25 which is formed, for example, from polyolefins or blends of polyamides and from whose top stalks 27 project which are not all numbered in FIG. 4. The thickened ends of the stalks 27 form mushroom-shaped or plate-shaped heads 29 which are not all numbered in the figures and which form the detachable interlocking in the installation process with the loops 21 on the adhesion closure part 9. The packing density in which the stalks 27 are provided on the carrier 25 depends on the mechanical structure and the fineness of the structure of the adhesive elements provided on the adhesion closure part 9. It goes without saying that instead of the loops 21 shown here there can be other types of structures, for example similar mushroom-like or plate-like heads on the stalks, as are provided in the base-side adhesion closure part 23. Depending on the fineness of the structures, the packing density in this connection can be several 100 adhesive elements/cm², and the thickness of the carrier 25 can be roughly in the region of 0.5 mm. Other packing densities and/or thicknesses of the carrier 25 are, of course, possible depending on special circumstances.

The selected different configuration of the adhesive elements on the base-side adhesion closure part 23 and on the other adhesion closure part 9 makes it possible to set the adhesive action as desired such that if the cover parts are to be re-installed, lifting is possible without the base-side adhesion closure part 23 being raised at the same time; this enables re-installation on the remaining adhesion closure part 23.

When an especially high adhesive action is desired, if, for example, re-installation is not an option, on the top of the heads 29 drops 31 of adhesive (in FIG. 4 likewise not all numbered) can be applied, for example, by spreading or doctoring in order to cause additional bonding after completed interlocking engagement with the adhesion closure part 9. The adhesives can be, for example, acrylate-based contact adhesives.

Instead of the illustrated structures of the adhesive elements on the adhesion closure parts 9 and 23, there can also be structures as are disclosed in DE 103 25 372 C1, i.e., adhesive elements which are formed from individual fibers which extend from the free end of stalks on which interlocking heads are not formed. As described in this document, in this connection there can be several 1000 stalks/cm² carrier surface, there being preferably approximately 500 individual fibers per stalk. The plastic material comprising the individual stalks and their individual fibers can be especially plastics with long molecular chains and good orientation behavior.

FIG. 5 shows in a schematically simplified form a commercial kit which contains the main components of the system according to the invention in a bag 33. The latter is made as a conventional plastic bag with an easily openable closure strip 35. In the bag 33, rolled into a spool 37, is the base-side adhesion closure part 23, rolled into a second spool 39, the adhesion closure part 9 assigned to the cover part and, rolled into a third spool 41, a corresponding length of the fixing part 11 in its initial state in which the film 17 which bears the active substance 15 is covered with a detachable protective film 13.

The illustrated fixing system can be also be made in the manner of a flame-retardant closure, the entire adhesion closure part 9 or components thereof consisting of materials which are poorly flammable, and these poorly flammable materials can also be made in the manner of an active extinguishing medium or contain these active extinguishing substances which can be applied to the respective adhesion closure part 9 also as a coating. It has been found to be especially advantageous to choose these materials from the following groups of substances:
ammonium phosphate (AP),
ammonium polyphosphate (APP),
aluminum trihydroxide (ATH),
magnesium hydroxide (MDH),
resorcinol bis-diphenyl phosphate (PDP),
red phosphorus (RP),
tri-n-butyl phosphate (TBP),
tricresyl phosphate (TCP),
triphenyl phosphate (TPP),
melamine.

Nanoparticles can also be incorporated into the carrier strip of the adhesion closure part 9, such as silicates or graphite, which likewise act in a flame retardant manner. The introduction of enclosed nitrogen gas in the form of nanoparticles into the adhesion closure part 9 would also be possible in order in this way to obtain an active extinguishing medium by way of an inert gas.

1. A fixing system consisting of at least one adhesion closure part (9) which can be fixed with its fixing side (7) on the free side (19) of the fixing part (11), whose other active side is at least partially provided with an activatable active substance (15) which when activated forms a fixing connection to the fixing side (5,; 6) of a third part (1, 3; 8).

2. The fixing system according to claim 1, characterized in that the third part is a carrier part, in particular a cushion foam part (8) of a vehicle or aircraft seat.

3. The fixing system according to claim 1, characterized in that the third part is a useful part, in particular a covering (1, 3, 5), preferably a floor or wall covering, the useful part having a useful surface (1, 3) opposite its fixing side (5).

4. The fixing system according to claim 3, characterized in that the covering is at least one carpet (1, 3, 5) or carpet tile with a carpet side (1) which forms the useful surface and a carpet back which forms the fixing side (5).

5. The fixing system according to claim 1, characterized in that the fixing part (11) is a flat article which is formed in particular from a plastic film (17) and which on at least one side is provided with an active substance (15), in particular is coated.

6. The fixing system according to claim 1, characterized in that the active substance (15) can be activated by heating.

7. The fixing system according to claim 6, characterized in that there is an active substance (15) which can be activated by heating to a temperature of less than 150° C., preferably less than 140° C.

8. The fixing system according to claim 7, characterized in that the active substance (15) consists of a blend of two thermoplastic substances, which blend has a softening point of not more than 125° C.

9. The fixing system according to claim 8, characterized in that the thermoplastic substances are chosen from the groups of copolyamides, polyethyl vinyl acetates, polyvinyl acetates, polyolefins, polyurethanes or copolyesters.

10. The fixing system according to claim 7, characterized in that the active substance (15) is a hot-melt adhesive based on synthetic rubber

11. The fixing system according to claim 5, characterized in that the active substance (15) on the flat article (17) is applied in an application amount from 80 to 400 g/m², preferably approximately 200 g/m².

12. The fixing system according to claim 11, characterized in that the flat article (17) which is coated with the active substance (15) is thermally stable in the temperature range which activates the active substance (15).

13. The fixing system according to claim 5, characterized in that the side of the fixing part (11), which side is provided with the active substance (15), is covered with a film (13) which protects the active substance (15) and which can be detached for exposing the active substance (15).

14. A process for installing coverings using a fixing system according to claim 3, with the following steps:
anchoring at least one adhesion closure part of one type (23) to a base, in particular a floor, such that the adhesion elements are located at the top,
pressing the fixing part (11) with the side which has the exposed active substance (15) onto the fixing side (5) of the covering (1, 3, 5) and heating in order to form a connection of the fixing part (11) to the fixing side (5) of the covering (1, 3, 5) by the activated active substance (15),
fixing another type of adhesion closure part (9) to the free side (19) of the fixing part (11) such that the adhesive elements (21) are exposed, and
connecting the adhesive elements of the two types of adhesion closure parts (23, 9) for fixing the respective covering (1, 3, 5) to the base, in particular the floor.

15. The process according to claim 14, characterized in that activation of the active substance (15) and pressing of the fixing part (11) onto the fixing side (5) of the covering (1, 3, 5) take place by a movable, heated pressing part, in particular such that the fixing part (11) is pressed onto the fixing side (5) of the covering (1, 3, 5).

16. A kit which has system parts of the fixing system according to claim 3 with at least the following components:
a closed bag (33) which can be opened for use,
a first spool (41) which is located in the bag (33) and in which a length of the fixing part (11) with the active substance (15) applied to one side and with an overlying, detachable protective film (13) is wound,
a second spool (39) which is located in the bag (33) and in which a length of the adhesion closure part (9) of a first type is wound, and
a third spool (37) which is located in the bag and in which a length of the adhesion closure part (23) of a second type is wound.
